(19) United States
(12) Patent Application Publication
(10) Pub. No.: US 2004/0045201 A1
(43) Pub. Date: Mar. 11, 2004

(54) Multi-layered, quick change signage system

(76) Inventors: David Robert Kalb, Brisbane, CA (US); Frank Xavier Doyle, Tiburon, CA (US)

Correspondence Address: Bruce H. Johnsonbaugh, Eckhoff & Hoppe, Suite 1700, Two Transamerica Center, 505 Sansome Street, San Francisco, CA, 94111, US

(21) Appl. No.: 10/657,459

(22) Filed: Sep. 8, 2003

Related U.S. Application Data
(60) Provisional application No. 60/409,828, filed on Sep. 9, 2002.

(51) Int. Cl. G09F 1/00

(52) U.S. Cl. 40/611.01; 40/446

(57) ABSTRACT

A multi-layered and quick change signage system is provided. A frame carries a transparent cover sheet and behind the transparent cover sheet the frame carries a plurality of opaque sheets, each of which contains a different graphic image. The transparent cover sheet also carries alphanumeric information such as a person's name and title. The user of the sign may quickly change the material displayed on the sign by simply changing the opaque sheet which is mounted immediately behind the transparent cover sheet. A non-glare plastic lens is carried on top of the transparent cover sheet. The signage system is particularly useful in conjunction with office cubicles.

### CROSS-REFERENCE TO RELATED APPLICATION

This application claims the benefit of and priority from United States provisional application Serial No. 60/409,828 filed Sep. 9, 2002.

### BACKGROUND AND BRIEF SUMMARY OF INVENTION

The present invention relates generally to signage systems. More particularly, the present invention provides a quickly changeable signage system for use, for example, as personnel identifiers. The signage system is used advantageously in conjunction with personnel cubicles. The signage system allows each individual to select a series of customized graphic images which may be used in conjunction with the alphanumeric information displayed on a transparent cover sheet of the sign. The selected graphic image is viewable through the transparent cover.

The prior art includes transparent sign supports as shown in the Mirza U.S. Pat. No. 6,347,471. However, Mirza does not teach a multi-layered sign in which a transparent cover includes alphanumeric information such as an individual's name and title and wherein a sheet behind or below the transparent cover sheet carries a selected graphic image.

The prior art also includes signage systems with transparent substrates. An example is the Lovison U.S. Pat. No. 5,223,357 wherein a holographic film is required. Another example is the Longobardi U.S. Pat. No. 4,933,218 which requires the use of thick ridges of viscous subject matter. The present invention does not require the use of holographic film or thick ridges of viscous ink.

The prior art also includes changeable signage systems such as the Whitehouse U.S. Pat. No. 5,428,914. The disadvantage of Whitehouse is that a rather cumbersome perforated base is required. The Kane U.S. Pat. No. 4,654,101 teaches a changeable display sign but it requires a relatively large number of separate component pieces to be interfitted in close abutting relationships. The present invention avoids the use of many separate pieces that have to be carefully interfitted together. Rather, the present invention utilizes a series of sheets that simply overlie each other and are carried by a rather simple frame.

A primary object of the invention is to provide a signage system wherein each individual sign includes an alphanumeric display and a graphic display and wherein the graphic display is readily interchangeable with alternate graphics.

A further object of the invention is to provide a signage system for use by personnel wherein each person is able to select his or her own custom set of graphic images to be displayed together with alphanumeric data describing the person and his or her position.

Another object of the invention is to provide a signage system wherein those portions of the system containing alphanumeric data and graphic images are readily transported to another location.

A further object of the invention is to provide a signage system wherein a transparent cover sheet is utilized which displays alphanumeric information and one or more opaque sheets may be interchangeably placed behind the cover sheet to display selected graphic images along with the alphanumeric data displayed by the cover sheet.

Other objects and advantages of the invention will become apparent from the following description and drawings wherein:

### BRIEF DESCRIPTION OF THE DRAWINGS

FIG. 1 is an exploded perspective view illustrating a preferred embodiment of the invention;

FIG. 2 is a front elevational view displaying the graphic image of a railroad locomotive behind a transparent cover sheet containing alphanumeric information pertaining to JANE DOE;

FIG. 3 is a front elevational view showing the same cover sheet used in FIG. 2 but wherein a different sheet carrying a graphic image of palm trees has been placed adjacent and behind the transparent cover sheet;

FIG. 4 is a front elevational view of the same sign wherein a third graphic image of a teed golf ball and head of a driver is displayed along with the alphanumeric information on the cover sheet; and

FIG. 5 shows a front elevational view of the sign displayed in FIGS. 2-4 wherein a fourth graphic image of a bird is displayed with the JANE DOE cover sheet.

### DETAILED DESCRIPTION OF THE DRAWINGS

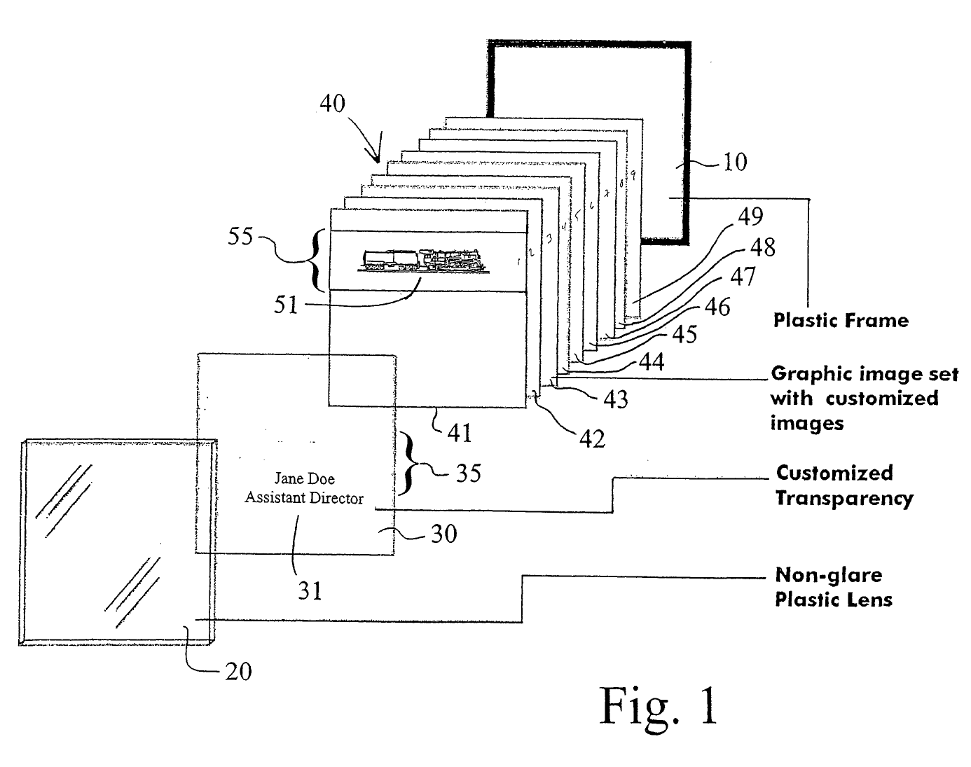

FIG. 1 is an exploded, perspective view illustrating one embodiment of the invention. A conventional plastic frame 10 is provided which may be connected to a wall or cubicle by any of a variety of connectors known in the art. For example, plastic frame 10 may be connected by picture hanging brackets, VELCRO or adhesive. Plastic frame 10 has a thickness to accommodate multiple layers of plastic or paper, as described below. Additionally, a non-glare plastic lens 20 is supported by frame 10. A customized transparency 30 is provided which is preferably transparent plastic. Transparency 30 carries an opaque alphanumeric display 31 which, as shown in FIG. 1, is JANE DOE ASSISTANT DIRECTOR. The opaque alphanumeric display of data is permanently attached to transparency 30 in a first region 35 of transparency 30. As shown in FIG. 1, the first region 35 is the lower half of transparency 30. Transparent cover sheet 30 has a second region 36 which is the top portion of sheet 30. Transparent cover sheet 30 is positioned immediately behind the non-glare plastic lens 20.

The invention also includes a layer of one or more graphic images carried on opaque sheets 41-49. The sheets 41-49 comprise a graphic image set 40 with customized images. For example, sheet 41 may carry a graphic image 51 of a train locomotive. The image 51 is displayed in region 55 of sheet 41 which as illustrated is in the upper portion of sheet 41 so the graphic image will not interfere with the alphanumeric image carried on transparency 30. Each of the separate sheets 4149 carries a different graphic image. Preferably the separate graphic images are selected by the particular employee to whom the sign pertains. The graphic images may be changed quickly by simply opening the non-glare plastic lens 20 relative to frame 10, selecting any desired graphic image displayed on sheets 41-49, moving that sheet forward so that it lies adjacent the transparent cover sheet 30 and reassembling plastic lens 20 into frame 10.

The signage system is also highly portable in that, if the individual to whom the sign pertains is transferred to a new cubicle or office, the transparency and sheets 41-49 are quickly removed by the employee and simply transported to his or her new location.

It is also within the scope of the invention to provide graphic images such as 51 which may be displayed over a larger portion of the sheet on which it is carried provided that the graphic image does not unduly interfere with the alphanumeric data carried on transparency 30. By “interfere” we mean that the graphic image renders all or a portion of the alphanumeric display illegible or unclear.

The sheets 41-49 carrying the graphic images are opaque and may be of any suitable material such as paper or plastic. The graphic images, such as 51, may be applied by a variety of techniques known in the art. The sheets 41-49 and cover sheet 30 form a stack of sheets of approximately the same size.

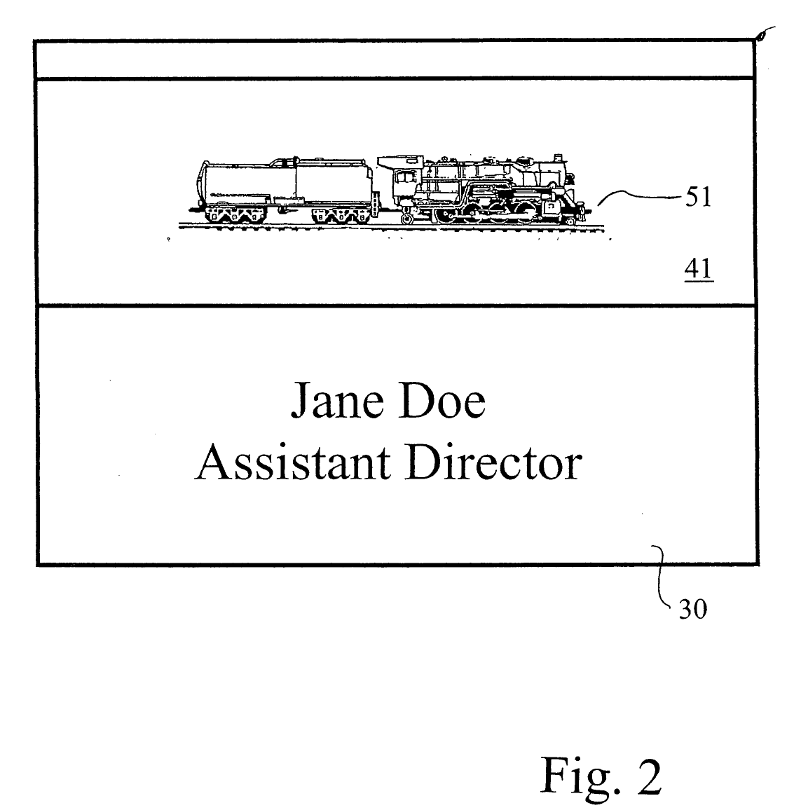

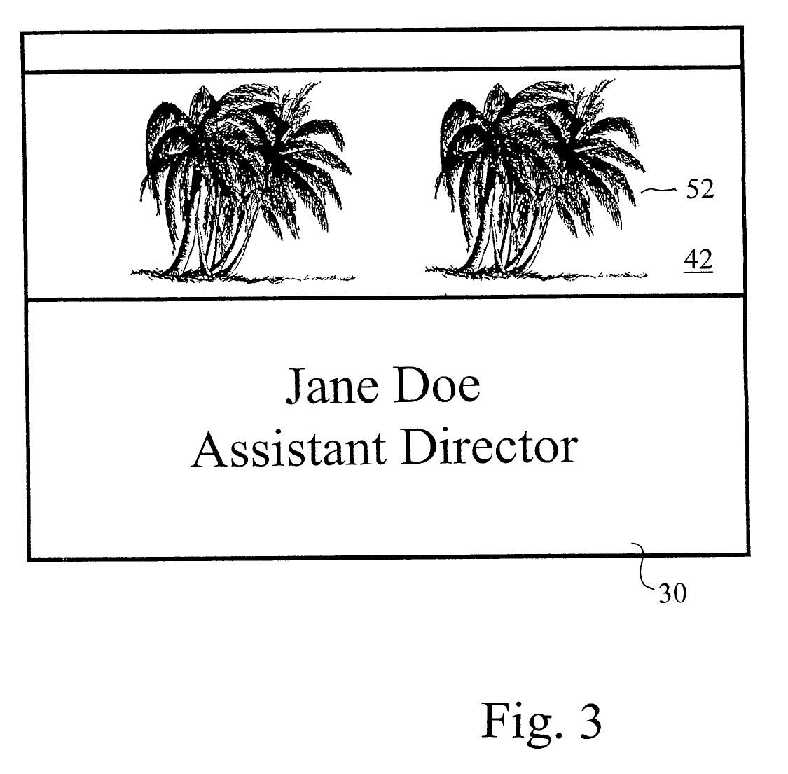

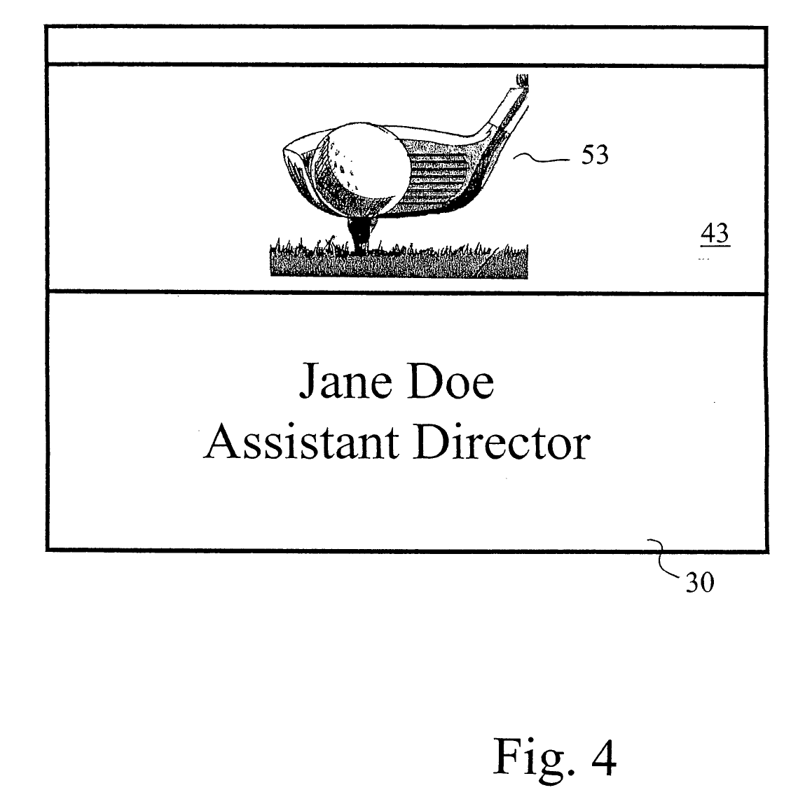

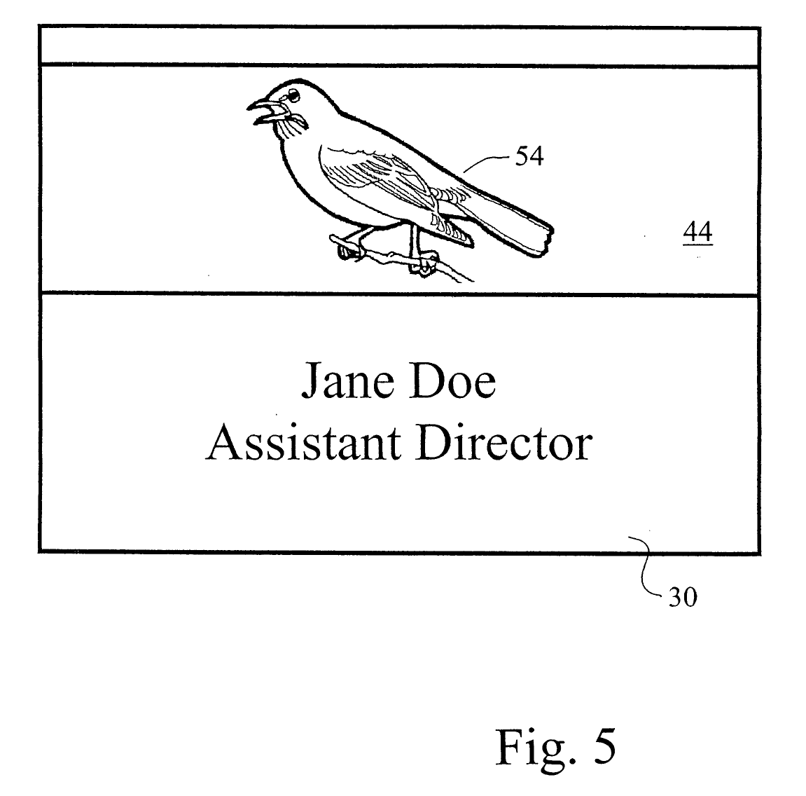

FIG. 2-5 are front elevational views illustrating how the graphic images can be readily changed. FIG. 2 contains the alphanumeric information JANE DOE ASSISTANT DIRECTOR carried by transparency 30. The graphic image 51 of a railroad locomotive is carried by sheet 41 and is clearly visible through the upper portion of transparency 30. FIG. 3 illustrates the appearance of the sign when sheet 42 carrying the graphic image of palm trees 52 has been placed adjacent and behind transparency 30. The sign now takes on an entirely new appearance from that shown in FIG. 2. FIG. 4 illustrates yet a third graphic image 53 of a teed up golf ball and the head of a driver on sheet 43 which has now been placed adjacent to transparency 30. FIG. 5 illustrates a graphic image of a bird 54 carried on sheet 44 when sheet 44 is placed adjacent to and immediately behind transparency 30.

As can be seen from FIGS. 2-5, the overall character of the sign for JANE DOE can be quickly changed by simply placing a desired sheet with a different graphic image behind transparent sheet 30.

Although the graphic images in FIG. 2-5 are shown displayed above the alphanumeric data, it is also within the scope of the invention to provide a graphic image that extends into the region of the alphanumeric data as well. For example, the graphic image may be of the sky, the beach, the ocean or a lake wherein the graphic image displayed behind the alphanumeric data does not conflict with or render the alphanumeric data illegible.

The foregoing description of the invention has been presented for purposes of illustration and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

What is claimed is:

1. A multi-layered signage apparatus wherein the material displayed may be quickly changed, comprising:
a frame,
one or more opaque sheets each containing a graphic image, said sheets removably carried by said frame, and
a cover sheet adapted to be carried by said frame on top of said opaque sheet or sheets, said cover sheet having a first region wherein alphanumeric information is displayed and a second region which is transparent,
whereby the material displayed by said sign is readily changeable by either inserting a different cover sheet or by inserting a different opaque sheet having a different graphic image behind said cover sheet.

2. The apparatus of claim 1 wherein said first region of said cover sheet is transparent except for said alphanumeric information.

3. The apparatus of claim 1 further comprising a non-glare plastic lens carried by said frame on top of said cover sheet.

4. The apparatus of claim 1 wherein said graphic image is placed on said opaque sheet in a region that will not interfere with said alphanumeric information on said cover sheet.

5. A multi-layered signage apparatus wherein the material displayed may be quickly changed, comprising:
a frame,
a plurality of opaque sheets each containing a different graphic image, said sheets forming a stack of sheets, and said stack of sheets removably carried by said frame, and
a transparent cover sheet carried by said frame on top of said stack of opaque sheet or sheets, said cover sheet having a first region wherein alphanumeric information is displayed and a transparent second region,
said graphic image on each of said opaque sheets being placed on said opaque sheets so that said image does not interfere with said alphanumeric information on said cover sheet, and
whereby the material displayed by said sign is readily changeable by either inserting a different cover sheet or by inserting a different opaque sheet having a different graphic image behind said cover sheet.

6. The apparatus of claim 5 wherein said first region of said cover sheet is transparent except for said alphanumeric information.

7. The apparatus of claim 5 further comprising a non-glare plastic lens carried by said frame on top of said cover sheet.
